(19) United States
(12) Patent Application Publication
(10) Pub. No.: US 2016/0293076 A1
(43) Pub. Date: Oct. 6, 2016

(54) DISPLAY DRIVING CIRCUIT AND SEMICONDUCTOR DEVICE INCLUDING THE SAME

(71) Applicant: Samsung Electronics Co., Ltd., Suwon-si (KR)

(72) Inventor: Woo-Seok Kim, Seoul (KR)

(21) Appl. No.: 14/992,257

(22) Filed: Jan. 11, 2016

(30) Foreign Application Priority Data
Apr. 6, 2015 (KR) 10-2015-0048474

(51) Int. Cl. G09G 3/00

(52) U.S. Cl. CPC G09G 3/006

(57) ABSTRACT

A display driving circuit includes a fault detector circuit which detects a fault in a circuit device and outputs a fault signal about the fault, a polarity selector circuit which stores polarity selection information and outputs a mode selection signal based on the polarity selection information, and a feedback circuit, wherein the feedback circuit includes an OR gate which receives an inverted signal of the mode selection signal and an inverted signal of the fault signal, an AND gate which receives the inverted signal of the mode selection signal and the fault signal, a first P-type transistor which is turned on or off by an output signal of the OR gate; and a first N-type transistor which is turned on or off by an output signal of the AND gate.

This application claims priority from Korean Patent Application No. 10-2015-0048474 filed on Apr. 6, 2015 in the Korean Intellectual Property Office, the disclosure of which is incorporated herein by reference in its entirety.

### BACKGROUND

1. Field of the Invention

The present inventive concepts relate to a display driving circuit, including a semiconductor device which includes a display driving circuit.

2. Description of the Related Art

As display devices become capable of providing higher resolution and deeper colors, an interface that may more stably provide an image data signal and a data control signal between a signal controller and a data driving chip is desired.

A display device may include a plurality of driving integrated circuits (“ICs”), also referred to herein interchangeably as display driving circuits. When a fault occurs in one or more of the driving ICs, a feedback circuit may feed information about the fault back to the other driving ICs and a controller of the display device.

In some cases, connecting input/output signals of multiple driving ICs to one another may result in an increase in the quantity of interfaces to the driving ICs, thereby increasing the complexity of one or more printed circuit boards (“PCB”) on which one or more of the driving ICs, controller, etc. are included. Increased complexity of a PCB may result in increased PCB complexity. Increased PCB complexity may result in increased PCB fabrication complexity.

In some cases, a display device may include an open-collector or open-drain circuit at an output terminal of one or more of the feedback circuits. The one or more open-collector or open-drain circuits may result in increased difficulty in enabling user-desired feedback signal customization, based on an open-collector or open-drain circuit included in a feedback circuit for a driving IC causing the feedback circuit of each driving IC to be fixed as an N-type circuit or a P-type circuit.

### SUMMARY

Some embodiments of the present inventive concepts provide a plurality of display driving circuits configured to output a feedback signal using one output terminal and select the polarity of the feedback signal as desired by a user.

Some embodiments of the present inventive concepts provide a semiconductor device including a plurality of display driving circuits configured to output a feedback signal using one output terminal and select the polarity of the feedback signal as desired by a user.

However, some embodiments of the present inventive concepts are not restricted to the one set forth herein. Some embodiments of the present inventive concepts will become more apparent to one of ordinary skill in the art to which the present inventive concepts pertain by referencing the detailed description of the present inventive concepts given below.

According to some embodiments of the present inventive concepts, there is provided a display driving circuit including a fault detector circuit configured to detect a fault in a circuit device and output a fault signal in response to the detection of the fault, a polarity selector circuit configured to store polarity selection information and generate a mode selection signal based on the polarity selection information, and a feedback circuit, wherein the feedback circuit includes an OR gate configured to receive both an inverted signal of the mode selection signal and an inverted signal of the fault signal, an AND gate configured to receive the inverted signal of the mode selection signal and the fault signal, a first P-type transistor configured to be selectively activated based on an output signal of the OR gate; and a first N-type transistor configured to be selectively activated based on an output signal of the AND gate.

According some embodiments of the present inventive concepts, there is provided a display driving circuit including a fault detector circuit configured to detect a fault in a circuit device and output a fault signal in response to the detection of the fault, a polarity selector circuit configured to store polarity selection information and output a mode selection signal based on the polarity selection information, and a feedback circuit configured to operate in a first mode when the mode selection signal is a first signal and operate in a second mode when the mode selection signal is a second signal which is an inverted signal of the first signal, wherein the feedback circuit is configured to, when operating in the first mode, output a high-level signal when the fault signal is at a low level and outputs a low-level signal when the fault signal is at a high level and, when operating in the second mode, output a high-level signal when the fault signal is at a high level and output a low-level signal when the fault signal is at a low level.

According to some embodiments of the present inventive concepts, there is provided a display driving circuit including a feedback circuit. The feedback circuit is configured to receive a fault signal, the fault signal including information associated with a fault in a circuit device, receive a mode selection signal, the mode selection signal being based on polarity selection information, generate a first-mode output signal when the mode selection signal is a first signal, the first-mode output signal having a signal strength which is inversely proportional to a signal strength of the fault signal, and generate a second-mode output signal when the mode selection signal is a second signal, the second signal being an inverted signal of the first signal, the second-mode output signal having a signal strength which is directly proportional to the signal strength of the fault signal.

According to some embodiments of the present inventive concepts, the display driving circuit may include a plurality of feedback circuits. An output terminal of each feedback circuit is coupled to an individual common connection terminal.

According to some embodiments of the present inventive concepts, the display driving circuit may include an external pull-up resistor connected to the individual common connection terminal. The feedback circuits may be configured to generate, at the common connection terminal, a low voltage signal based on at least one of the feedback circuits receiving a low-level fault signal.

According to some embodiments of the present inventive concepts, the display driving circuit may include an external pull-down resistor connected to the individual common connection terminal. The feedback circuits may be configured to generate, at the common connection terminal, a high voltage signal based at least in part upon each of the feedback circuits receiving a low-level fault signal.

### BRIEF DESCRIPTION OF THE DRAWINGS

The above and other aspects and features of the present inventive concepts will become more apparent by describing in detail exemplary embodiments thereof with reference to the attached drawings, in which:

FIG. 1 is a block diagram of a display device, according to some embodiments of the present inventive concepts;

FIG. 2 is a block diagram of a semiconductor device including display driving circuits, according to some embodiments of the present inventive concepts;

FIG. 3 is a circuit diagram of a feedback circuit of a display driving circuit, according to some embodiments of the present inventive concepts;

FIG. 4 is a circuit diagram illustrating the operation of the display driving circuit, according to some embodiments of the present inventive concepts;

FIG. 5 is a circuit diagram illustrating the operation of the display driving circuit, according to some embodiments of the present inventive concepts;

FIG. 6 is a circuit diagram of a feedback circuit of a display driving circuit, according to some embodiments of the present inventive concepts;

FIG. 7 is a circuit diagram of a feedback circuit of a display driving circuit, according to some embodiments of the present inventive concepts;

FIG. 8 is a circuit diagram of a feedback circuit of a display driving circuit, according to some embodiments of the present inventive concepts;

FIG. 9 is a circuit diagram illustrating the operation of the display driving circuit, according to some embodiments of the present inventive concepts;

FIG. 10 is a truth table illustrating the operation of the display driving circuit, according to some embodiments of the present inventive concepts;

FIG. 11 is a circuit diagram illustrating the operation of the display driving circuit, according to some embodiments of the present inventive concepts;

FIG. 12 is a truth table illustrating the operation of the display driving circuit, according to some embodiments of the present inventive concepts;

FIG. 13 is a block diagram of a semiconductor device including display driving circuits, according to some embodiments of the present inventive concepts;

FIG. 14 is a circuit diagram of a protector circuit included in the display driving circuit, according to some embodiments of the present inventive concepts;

FIG. 15 illustrates a display module, according to some embodiments of the present inventive concepts;

FIG. 16 illustrates a display system, according to some embodiments of the present inventive concepts; and

FIG. 17 illustrates various examples of an electronic product loaded with a display device, according to some embodiments of the present inventive concepts.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION OF THE EMBODIMENTS

Advantages and features of the present inventive concepts and methods of accomplishing the same may be understood more readily by reference to the following detailed description of preferred embodiments and the accompanying drawings. The present inventive concepts may, however, be embodied in many different forms and should not be construed as being limited to the embodiments set forth herein. Rather, these embodiments are provided so that this disclosure will be thorough and complete and will fully convey the concepts of the inventive concepts to those skilled in the art, and the present inventive concepts will only be defined by the appended claims. Like reference numerals refer to like elements throughout the specification.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it may be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, where the device in the figures is turned over, elements described as “below” or “beneath” other elements or features would then be oriented “above” the other elements or features. Thus, the exemplary term “below” may encompass both an orientation of above and below. The device may be otherwise oriented (rotated 90 degrees or at other orientations) and the spatially relative descriptors used herein interpreted accordingly.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which the present inventive concepts belong. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware, software, and/or a combination thereof. For example, hardware devices may be implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

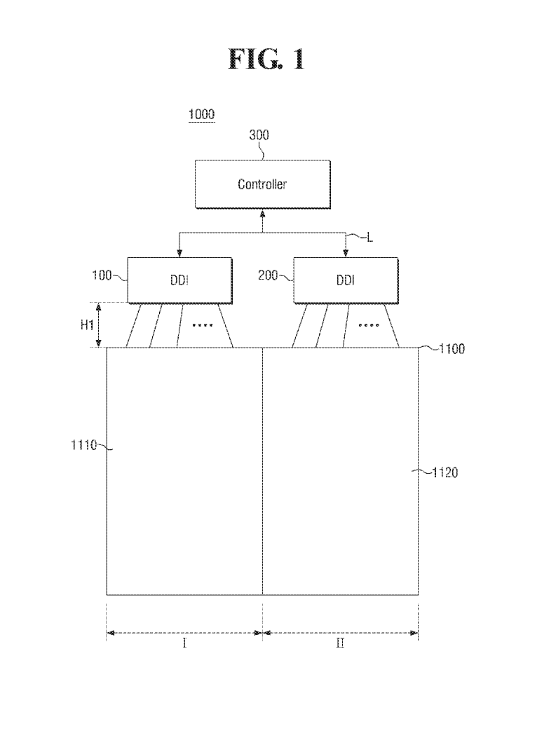

Hereinafter, display driving circuits according to some embodiments of the present inventive concepts and semiconductor devices including the same will be described with reference to FIGS. 1 through 14.

FIG. 1 is a block diagram of a display device 1000, according to some embodiments of the present inventive concepts.

Referring to FIG. 1, the display device 1000 according to the embodiment may include any one of various display devices, including an organic light-emitting diode display (OLED), a liquid crystal display (LCD), a plasma display panel (PDP), an electrochromic display (ECD), a digital mirror device (DMD), an actuated mirror device (AMD), a grating light value (GLV), a plasma display panel (PDP), and an electroluminescent display (ELD).

In some embodiments, the display device 1000 may include a controller 300, a plurality of display driving circuits 100 and 200, and a display panel 1100.

The display panel 1100 is divided into a plurality of areas I and II. For ease of description, the display panel 1100 is divided into two areas I and II in FIG. 1. In some embodiments, the display panel 1100 may also be divided into two or more areas. The areas I and II of the display panel 1100 may be matched with the display driving circuits 100 and 200 and controlled by the display driving circuits 100 and 200, respectively. Although not specifically illustrated in the drawing, in some embodiments the display panel 1100 may include a plurality of gate lines (not illustrated), a plurality of data lines (not illustrated), and a plurality of pixels (not illustrated).

In some embodiments, the display device 1000 may include a plurality of display panels 1110 and 1120. The display panels 1110 and 1120 may be matched with the display driving circuits 100 and 200 and controlled by the display driving circuits 100 and 200, respectively. The display panels 1110 and 1120 may include separate and independent panels. However, the present inventive concepts are not limited thereto, and, in some embodiments, the display panels 1110 and 1120 may include separate areas included in a common individual display panel.

Each of the display driving circuits 100 and 200 may include one or more of a display driving circuit IC (DDI), a source IC, a gate IC, or an LCD driving IC (LDI). Each individual display driving circuit, of the display driving circuits 100 and 200, may separate a data signal from a data packet received from the controller 300. For example, individual display driving circuit 100 may sample a data packet, received at display driving circuit 100 from controller 300, at appropriate timing and extract a data signal from the data packet, based on a clock signal embedded in the data packet. The display driving circuit 100 may transmit the extracted data signal to the display panel 1100. The display driving circuits 100 and 200 may be included in an OLED device.

In some embodiments which include display panel 1100 being driven based on operation of a plurality of display driving circuits 100-200 (i.e., controlled by the plurality of display driving circuits 100-200), such driving of the display panel 1100 may result in a reduction of the size of the display device 1000.

For example, where one display panel 1100 is controlled by a plurality of display driving circuits 100-200, the distance H1 from the display driving circuits 100 and 200 to the display panel 1100 may be significantly reduced, relative to a distance H1 in a display device 1000 where panel 1100 is driven by an individual display driving circuit, of the display driving circuits 100-200. As a result, a display device 1000 which includes a display panel 1100 which is driven by a plurality of the display driving circuits 100-200 may be reduced, in size, relative to a display device 1000 which includes a display panel 1100 which is driven by an individual display driving circuit of display driving circuits 100-200.

In some embodiments, a display device 1000 may be configured to control a plurality of display panels 1110 and 1120. For example, when a fault occurs in any one of the display panels 1110 and 1120, the display driving circuits 100 and 200 may, in response to detection of the fault, stop transmitting signals to the display panels 1110 and 1120 and then control the display panels 1110 and 1120 to cause the display panels 1110 and 1120 to operate normally. In some embodiments, each of the display driving circuits 100 and 200 may determine whether a fault has occurred in a corresponding one of the display panels 1110 and 1120.

The controller 300 may receive a fault that has occurred in the display driving circuits 100 and 200 and perform an operation for recovering the fault. In some embodiments, in response to a fault in the display panels 1110 and 1120 being detected in at least any one of the display driving circuits 100 and 200, the controller 300 may transmit a recovery command to the corresponding display driving circuit 100 or 200, where the transmitted recovery command causes the display driving circuit 100 or 200 to recover from the fault. For example, the controller 300 may generate a system recovery signal SYS_PRT for system recovery and transmit the system recovery signal SYS_PRT to the display driving circuits 100 and 200, but the present inventive concepts are not limited thereto.

In some embodiments, the controller 300 and the display driving circuits 100 and 200 may be connected to each other via one or more channels, interfaces, etc. For example, one controller 300 may be connected in parallel to the display driving circuits 100 and 200 via connection line L.

The specific operation of the controller 300 and the display driving circuits 100 and 200 will be described in detail later.

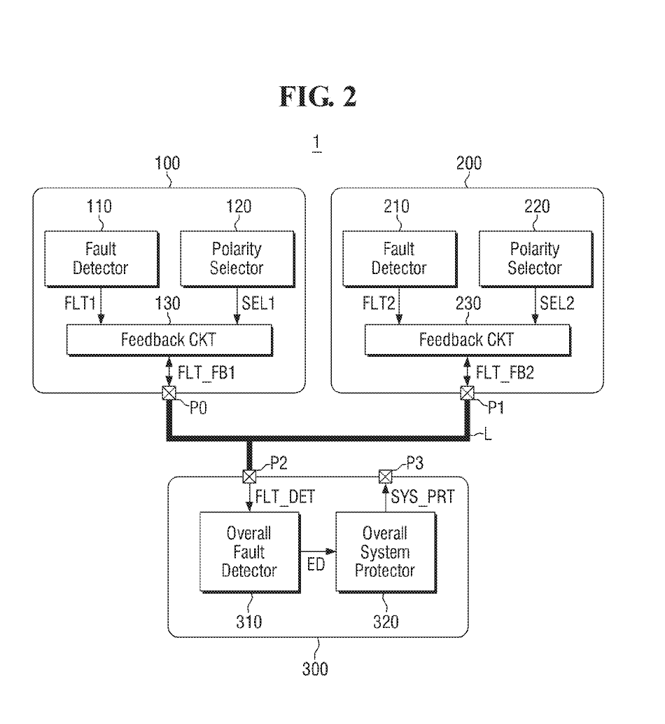

FIG. 2 is a block diagram of a semiconductor device 1 including display driving circuits, according to some embodiments of the present inventive concepts.

Referring to FIG. 2, the semiconductor device 1 of the present inventive concepts includes a first driving circuit 100, a second driving circuit 200, and a controller 300.

The first driving circuit 100 may include a fault detector circuit 110, a polarity selector circuit 120, and a feedback circuit 130. The second driving circuit 200 may include a fault detector circuit 210, a polarity selector circuit 220, and a feedback circuit 230. The second driving circuit 200 may operate substantially similarly to the first driving circuit 100. Thus, each component of the first driving circuit 100 will hereinafter be described.

The fault detector circuit 110 may detect a fault in a circuit device and output a fault signal FLT1 about the fault. It will be understood that components described as outputting a signal may also generate the signal, even though such generation may not be explicitly stated. The fault signal FLT1 generated by the fault detector circuit 110 may be communicated, from the fault detector circuit 110, as an input to the feedback circuit 130.

In some embodiments, the circuit device may include a display panel 1100. For example, referring to FIG. 1, the fault detector circuit 110 included in the first driving circuit 100 may detect a fault in a first display panel 1110, and the fault detector circuit 210 may detect a fault in a second display panel 1120. In some embodiments, faults that occur in the display panel 1100 may include all cases where the display panel 1100 cannot generate a normal output. For example, when a fault occurs in the display panel 1100, the display panel 1100 may output noise, or may fail to generate an output corresponding to an input signal. However, the present inventive concepts are not limited thereto.

In response to a fault occurring in the display panel 1100, the fault detector circuit 110 may output a high-level signal as the fault signal FLT1. For example, where the fault signal FLT1 has a logic value of ‘1,’ the controller 300 which receives the fault signal FLT1 may determine that a fault has occurred in the display panel 1100. However, the present inventive concepts are not limited thereto.

The polarity selector circuit 120 may be configured to store polarity selection information and output a mode selection signal SEL1 based on the polarity selection information. For example, the polarity selector circuit 120 may include one or more of a memory (not illustrated) or a polarizer selection terminal (not illustrated) which receives polarity information.

The memory (not illustrated) may determine polarity selection information corresponding to a desired (or alternatively, predetermined) value. For example, the memory (not illustrated) may store a first signal value (e.g., logic value 1) or a second signal value (e.g., logic value 0) as the polarity selection information. The polarity selection information may be set or changed by a user, a manufacturer, some combination thereof, etc.

The polarity selection terminal (not illustrated) may be connected to a polarity selector circuit 120, where the polarity selection terminal is located external to the first driving circuit 100. The polarity selector circuit 120 may generate the mode selection signal SEL1 using a voltage level of the polarity selection terminal (not illustrated). For example, the polarity selection terminal (not illustrated) may be connected to a IC power supply (“VDD”) or ground (“GND”) terminal. The polarity selection terminal may have a voltage level corresponding to logic value 1 or logic value 0. The polarity selector circuit 120 may be configured to generate a mode selection signal SEL1 corresponding to the first signal value (e.g., logic value 1) or the second signal value (e.g., logic value 0) based on the voltage level of the polarity selection terminal. A user of the semiconductor device 1, according to some embodiments, may be enabled to change the polarity selection information via user interaction with the polarity selection terminal (not illustrated), but the present inventive concepts are not limited thereto.

The feedback circuit 130 may operate in a first mode or a second mode based on the mode selection signal SEL1. The first mode may be, but is not limited to, a low active mode, and the second mode may be, but is not limited to, a high active mode.

The feedback circuit 130 may operate in a “first mode” in response to the mode selection signal being a “first signal,” and the feedback circuit 130 may operate in a “second mode in response to the mode selection signal being a “second signal.” The “first signal” may be a desired signal (or alternatively, a predetermined signal). The “second signal” may be an inverted signal of the first signal. For example, the “first signal” may be a mode selection signal SEL1 which is a low-level signal, and the “second signal” may be a mode selection signal SEL1 which is a high-level signal.

When operating in either the first mode or the second mode, the feedback circuit 130 may output signals in response to the input fault signal FLT1.

When operating in the first mode, the feedback circuit 130 may output signals which have a signal strength which varies in inverse proportion to the signal strength of the input fault signal FLT1. For example, the feedback circuit 130 may output a high-level signal in response to the input fault signal FLT1 being a low-level signal, and the feedback circuit 130 may output a low-level signal in response to the fault signal FLT1 being a high-level signal. It will be understood that a signal outputted by the feedback circuit when the feedback circuit is operating in the first mode may be a “first-mode output signal,” even though the signal may not be explicitly described as such.

When operating in the second mode, the feedback circuit 130 may output signals which have a signal strength which varies in direct proportion to the signal strength of the input fault signal FLT1. For example, the feedback circuit 130 may output a high-level signal in response to the input fault signal FLT1 being a high-level signal, and the feedback circuit 130 may output a low-level signal in response to the fault signal FLT1 being a low-level signal. It will be understood that a signal outputted by the feedback circuit when the feedback circuit is operating in the second mode may be a “second-mode output signal,” even though the signal may not be explicitly described as such.

As the mode selection signal SEL1 is changed, the feedback circuit 130 may, in response, change a voltage level of an output signal FLT_FB1 generated by the feedback circuit 130 in response to a received fault signal FLT1. Accordingly, a user may be enabled to customize the output signal FLT_FB1 of the feedback circuit 130 as desired by changing the mode selection signal SEL1. It will be understood that a “level” of a signal may also include a voltage level of the signal, a strength of the signal, some combination thereof, or the like.

The controller 300 may receive output signals from the driving circuits 100 and 200, where output signals from one or more driving circuits may be interchangeably referred to herein as output signals generated by the one or more driving circuits, output signals of the one or more driving circuits, etc., via an individual common connection terminal P2. For example, the controller 300 may receive the first output signal FLT_FB1 of the first driving circuit 100 and a second output signal FLT_FB2 of the second driving circuit 200 through a common connection terminal P2, and the controller 300 may generate a system recovery signal SYS_PRT based on a voltage of the common connection terminal P2, where the voltage of the common connection terminal P2 may be based on the strength of the first output signal FLT_FB1 and the strength of the second output signal FLT_FB2, including a cumulative strength of the first output signal and the second output signal.

The controller 300 may generate the system recovery signal SYS_PRT in response to receiving one or more fault signals generated by one or more of the first driving circuit 100 or the second driving circuit 200 via the common connection terminal P2. The first driving circuit 100 may generate the first fault signal FLT1, at fault detector circuit 110, in response to detecting a fault in the first display panel 1110, and the first driving circuit may generate the first output signal FLT_FB1, at the feedback circuit 130, in response to the first fault signal FLT1 generated at fault detector circuit 110 and provided as input from fault detector circuit 110 to the feedback circuit 130, where the signal strength of the first output signal FLT_FB1 is based on the signal strength of the first fault signal FLT1. The second driving circuit 200 may generate a second fault signal FLT2, at fault detector circuit 210, in response to detecting a fault in the second display panel 1120, and the second driving circuit may generate the second output signal FLT_FB2, at the feedback circuit 230, in response to the second fault signal FLT2 generated at fault detector circuit 210 and provided as input from fault detector circuit 210 to the feedback circuit 230, where the signal strength of the second output signal FLT_FB2 is based on the signal strength of the second fault signal FLT2. In some embodiments, the first output signal FLT_FB1 and the second output signal FLT_FB2 have a common signal strength, also referred to herein as a common value, based on an output terminal P0 of the first driving circuit 100 and an output terminal P1 of the second driving circuit 200 being connected by the same line L.

The system recovery signal SYS_PRT may be generated, at controller 300, based on both the first output signal FLT_FB1 of the first driving circuit 100 and the second output signal FLT_FB2 of the second driving circuit 200.

Specifically, the controller 300 may include an overall fault detector circuit 310 and an overall system protector circuit 320. The overall fault detector circuit 310 may activate a fault detect signal ED, where activating a signal may also be referred to herein interchangeably as generating a signal, based on the voltage of the common connection terminal P2. When the fault detect signal ED is activated, the overall system protector circuit 320 may generate the system recovery signal SYS_PRT based on the fault detect signal ED.

The controller 300 may generate the system recovery signal SYS_PRT based on both the voltage of the common connection terminal P2 and the mode selection signal SEL. For example, where the mode selection signal SEL1 is a first signal, the controller 300 may generate the system recovery signal SYS_PRT in response to a low voltage of the common connection terminal P2. In another example, where the mode selection signal SEL1 is a second signal, the controller 300 may generate the system recovery signal SYS_PRT in response to a high voltage of the common connection terminal P2. The second signal may be an inverted signal of the first signal.

In some embodiments, the generated system recovery signal SYS_PRT may be transmitted, from controller 300, to the first driving circuit 100 and the second driving circuit 200 via an output port P3. The first driving circuit 100 and the second driving circuit 200 which receive the system recovery signal SYS_PRT may perform an operation of recovering the entire display system, in response to receipt of the system recovery signal SYS_PRT. For example, the first driving circuit 100 and the second driving circuit 200 which receive the system recovery signal SYS_PRT may, in response to receiving the system recovery signal SYS_PRT, stop the operation of the first display panel 1110 and the second display panel 1120. Subsequently to stopping the operation of the first display panel 1110 and the second display panel 1120, the first driving circuit 100 and the second driving circuit 200 may control the first display panel 1110 and the second display panel 1120 to operate normally again. However, the present inventive concepts are not limited thereto.

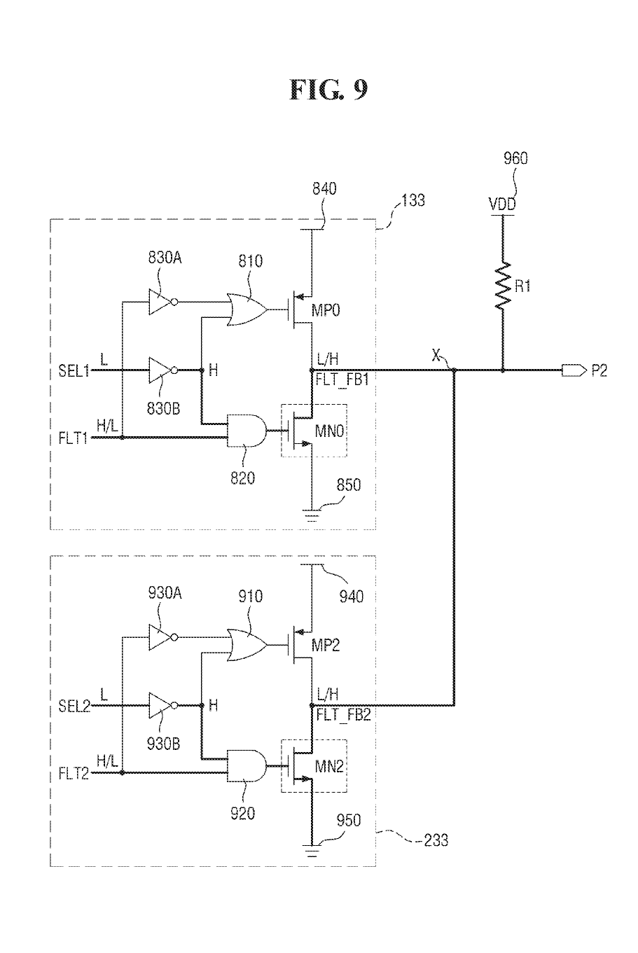

In some embodiments, the controller 300 may generate the system recovery signal SYS_PRT in response to the mode selection signal SEL1 being the first signal and further in response to at least one of the first output signal and second output signal FLT_FB1 and FLT_FB2 being a low voltage level. In another example, the controller 300 may generate the system recovery signal SYS_PRT in response to the mode selection signal SEL1 being the second signal which is the inverted signal of the first signal and further in response to at least one of the first output signal and second output signal FLT_FB1 and FLT_FB2 being a high voltage level. This will be described in detail later with reference to FIGS. 9 through 12.

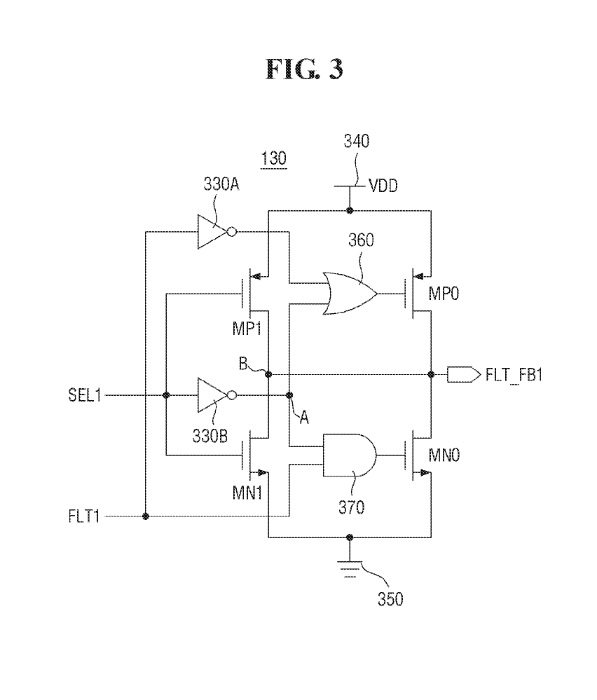

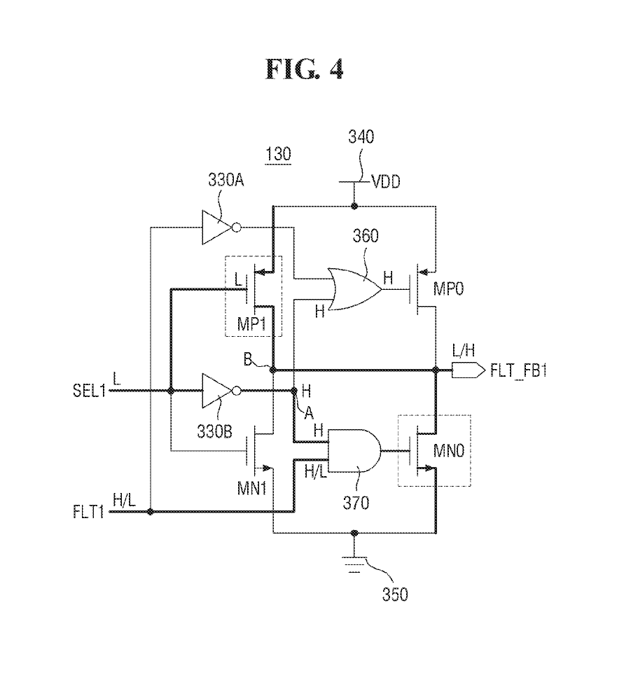

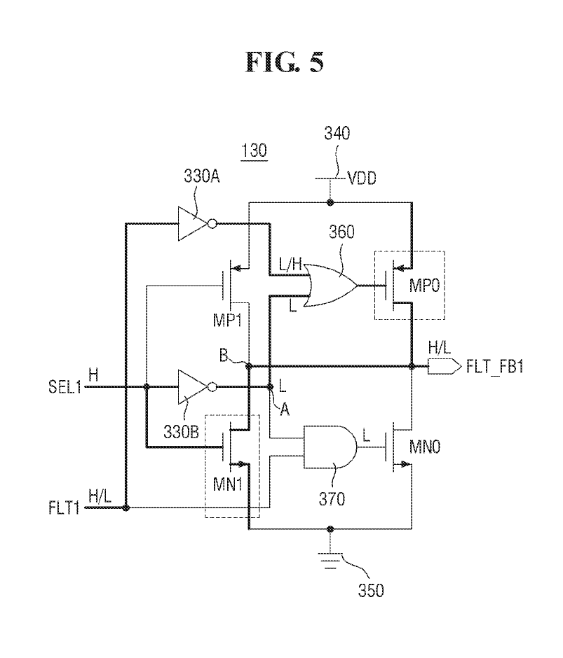

FIG. 3 is a circuit diagram of a feedback circuit 130 of a display driving circuit, according to some embodiments of the present inventive concepts. FIG. 4 is a circuit diagram illustrating the operation of the display driving circuit, according to some embodiments of the present inventive concepts. FIG. 5 is a circuit diagram illustrating the operation of the display driving circuit, according to some embodiments of the present inventive concepts.

Referring to FIGS. 3 through 5, the feedback circuit 130 may include a first P-type transistor MP0, a second P-type transistor MP1, a first N-type transistor MN0, a second N-type transistor MN1, an OR gate 360, an AND gate 370, and inverters 330A-B. Since the first driving circuit 100 and the second driving circuit 200 are configured and operated in substantially the same way, the feedback circuit 130 included in the first driving circuit 100 will hereinafter be described.

The feedback circuit 130 may receive the mode selection signal SEL1 of the polarity selector circuit 120 and the fault signal FLT1 of the fault detector circuit 110.

Specifically, the feedback circuit 130, as shown in FIG. 3-5, may include the OR gate 360 which receives an inverted signal of the mode selection signal SEL1 and an inverted signal of the fault signal FLT1, the AND gate 370 which receives the inverted signal of the mode selection signal SEL1 and the fault signal FLT1, the first P-type transistor MP0 which is turned on or off by an output signal of the OR gate 360, and the first N-type transistor MN0 which is selectively activated by an output signal of the AND gate 370.

Here, each of the first P-type transistor MP0 and the second P-type transistor MP1 has a source terminal connected to a VDD terminal 340 and a drain terminal connected to an output node. Each of the first N-type transistor MN0 and the second N-type transistor MN1 has a source terminal connected to a GND terminal 350 and a drain terminal connected to an output node. The first P-type transistor MP0 is gated by the output signal of the OR gate 360, and the second P-type transistor MP1 is gated by the mode selection signal SEL1. The first N-type transistor MN0 is gated by the output signal of the AND gate 370, and the second N-type transistor MN1 is gated by the mode selection signal SEL1.

In some embodiments, one or more of the first N-type transistor MN0, the first P-type transistor MP0, the second N-type transistor MN1, or the second P-type transistor MP1 may include one or more of a metal oxide semiconductor field effect transistor (MOSFET) or a bipolar junction transistor (BJT).

In addition, the first P-type transistor MP0 and the first N-type transistor MN0 may share an output terminal, and the output terminal may be connected to the first P-type transistor MP0 and the first N-type transistor MN0 in an open-drain or open-collector configuration.

The feedback circuit 130 may select any one of the first N-type transistor MN0 and the first P-type transistor MP0 based on the input mode selection signal SEL1 and activate the selected transistor based on the fault signal FLT1, thereby selectively activating any one of the first N-type transistor MN0 and the first P-type transistor MP0 based on both the input mode selection signal SEL1 and the fault signal FLT1.

FIG. 4 illustrates feedback circuit 130 receiving a mode selection signal SEL1 which is a first signal. As shown in FIG. 4, the feedback circuit 130 may operate in a “first mode” in response to the model selection signal SEL1 being the first signal. Operating in the “first mode” may include the feedback circuit 130 deactivating the first P-type transistor MP0 and selectively activating the first N-type transistor MN0 based on the signal strength of the fault signal FLT1. For example, when the mode selection signal SEL1 is a first signal which has a low level (logic value 0), the first P-type transistor MP0 may be continuously deactivated, and the first N-type transistor MN0 may be turned on or off (“selectively activated”) according to the signal strength of the fault signal FLT1. It will be understood that an element described as being “turned on or off” may also be “selectively activated,” even though such selective activation may not be explicitly stated As shown in FIG. 4, the second N-type transistor MN1 may be continuously deactivated, and the second P-type transistor MP1 may be configured to operate as a pull-up resistor. The feedback circuit operating in a first mode in response to the mode selection signal SEL1 being a first signal (e.g., logic 0, “low-level signal”, etc.) may include the feedback circuit 130 operating in a low active mode by deactivating the first P-type transistor MP0 and the second N-type transistor MN1 and selectively activating the second P-type transistor MP1 and the first N-type transistor MN0 based on the signal strength of the fault signal FLT1. For example, when the feedback circuit 130 is operating in the first mode, the feedback circuit 130 may activate the first N-type transistor MN0 in response to the fault signal FLT1 being a high-level signal (e.g., logic value 1).

Accordingly, when the feedback circuit 130 is operating in the first mode, the feedback circuit 130 may generate an output signal FLT_FB1 which is a low-level signal in response to the fault signal FLT1 being a high-level signal, and the feedback circuit 130 may generate an output signal FLT_FB1 which is a high-level signal in response to the fault signal FLT1 being a low-level signal.

Additionally, transport conductance of the second P-type transistor MP1 may be, but is not limited to, smaller than the transport conductance of the first N-type transistor MN0, such that the first N-type transistor MN0 may be connected to the output terminal in an open-drain or open-collector manner, and that the second P-type transistor MP1 may be configured to operate as a pull-up resistor, when the feedback circuit 130 is operating in the first mode.

FIG. 5 illustrates feedback circuit 130 receiving a the mode selection signal SEL1 which is a second signal. The second signal is the inverted signal of the first signal illustrated in FIG. 4. As shown in FIG. 5, the feedback circuit 130 may operate in a “second mode” in response to the model selection signal SEL being the second signal. Operating in the “first mode” may include the feedback circuit 130 deactivating the first N-type transistor MN0 and selectively activating the first P-type transistor MP0 based on the signal strength of the fault signal FLT1. For example, when the mode selection signal SEL1 is a second signal which has a high level (logic 1)), the first N-type transistor MN0 may be continuously deactivated, and the first P-type transistor MP0 may be selectively activated according to the fault signal FLT1 signal strength. As shown in FIG. 5, the second P-type transistor MP1 may be continuously deactivated, and the second N-type transistor MN1 may operate as a pull-down resistor. The feedback circuit operating in a second mode in response to the mode selection signal SEL1 being a second signal (e.g., logic 1, “high-level signal”, etc.) which is the inverted signal of the first signal may include the feedback circuit 130 operating in a high active mode by deactivating the first N-type transistor MN0 and the second P-type transistor MP1 and selectively activating the second N-type transistor MN1 and the first P-type transistor MP0 based on the signal strength of the fault signal FLT1. For example, when the feedback circuit 130 is operating in the second mode, the feedback circuit 130 may activate the first P-type transistor MP0 in response to the fault signal FLT1 being a high-level signal (e.g., logic value 1).

Accordingly, when the feedback circuit 130 is operating in the first mode, the feedback circuit 130 may generate an output signal FLT_FB1 which is a high-level signal in response to the fault signal FLT1 being a high-level signal, and the feedback circuit 130 may generate an output signal FLT_FB1 which is a low-level signal when the fault signal FLT1 is a low-level signal.

Additionally, transport conductance of the second N-type transistor MN1 may be, but is not limited to, smaller than the transport conductance of the first P-type transistor MP0 such that the first P-type transistor MP0 may be connected to the output terminal in an open-drain or open-collector manner, and that the second N-type transistor MN1 may operate as a pull-down resistor, when the feedback circuit 130 is operating in the second mode.

While the illustrated examples in FIG. 3-5 illustrate the first signal as being a low-level signal, such that the feedback circuit 130 operates in the first mode in response to a low-level mode selection signal SEL1 and further operates in the second mode in response to a high-level model selection signal SEL1, which is the inverse of the low-level mode selection signal SEL1, it will be understood that, in some embodiments, the first signal may be a high-level signal, and the feedback circuit 130 may be configured to operate in a first mode, such that the first P-type transistor MP0 is deactivated and the first N-type transistor MN0 is selectively activated based on the fault signal FLT1, in response to the mode selection signal SEL1 being a particular first signal which is a high-level signal.

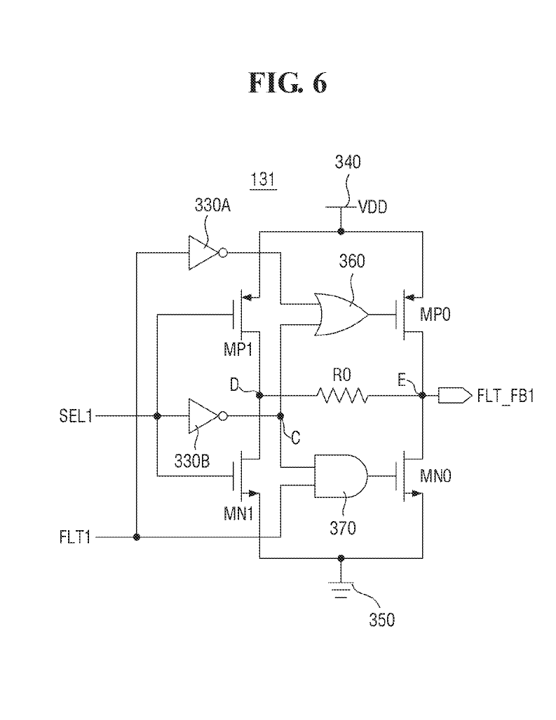

FIG. 6 is a circuit diagram of a feedback circuit 131 of a display driving circuit, according to some embodiments of the present inventive concepts. For simplicity, a description of elements substantially identical to those of the previous embodiment will be omitted, and the current embodiment will hereinafter be described with regard to differences of the illustrated feedback circuit from the embodiments of feedback circuits illustrated in FIG. 3-5.

Referring to FIG. 6, the feedback circuit 131 may be configured and operated in substantially the same way as the feedback circuit 130 described above with reference to FIGS. 3 through 5. In some embodiments, the feedback circuit 131 includes an internal resistor R0 which may be located between a node E, to which a drain of a first P-type transistor MP0 and a drain of a first N-type transistor MN0 are connected, and a node D, to which a drain of a second P-type transistor MP1 and a drain of a second N-type transistor MN1 are connected. The internal resistor R0 may be configured to operate as one or more of a pull-up resistor or a pull-down resistor.

In some embodiments, the internal resistor R0 may cause transport conductance of the second P-type transistor MP1 to be at least as low as the transport conductance of the first N-type transistor MN0. In some embodiments, the internal resistor R0 may cause transport conductance of the second N-type transistor MN1 to be at least as low as the transport conductance of the first P-type transistor MP0. However, the present inventive concepts are not limited thereto.

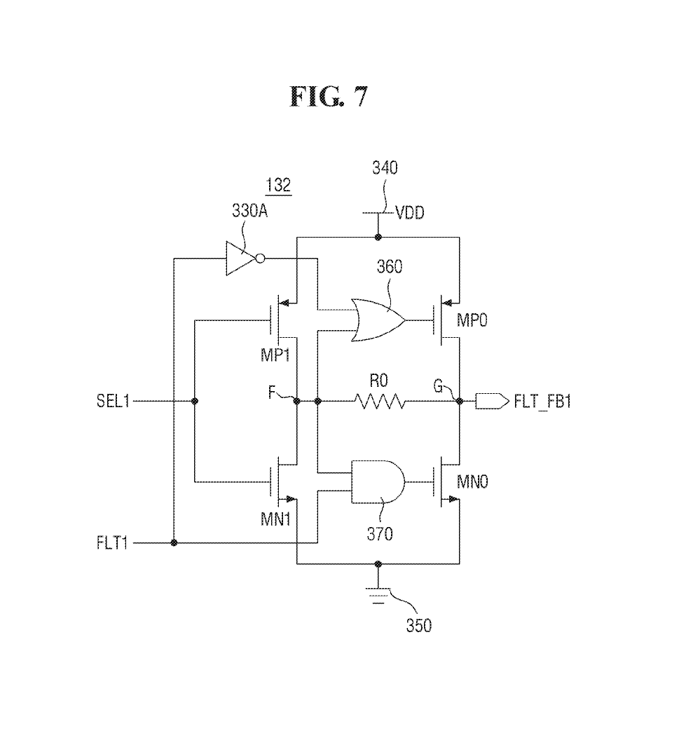

FIG. 7 is a circuit diagram of a feedback circuit 132 of a display driving circuit, according to some embodiments of the present inventive concepts. For simplicity, a description of elements substantially identical to those of the previous embodiments will be omitted, and the current embodiment will hereinafter be described with regard to differences of the illustrated feedback circuit from the embodiments of feedback circuits illustrated in FIG. 3-5.

Referring to FIG. 7, the feedback circuit 132 may be configured and operated in substantially the same way as the feedback circuit 130 described above with reference to FIGS. 3 through 5. In some embodiments, the feedback circuit 132 includes an internal resistor R0 which may be located between a node F, to which a drain of a first P-type transistor MP0 and a drain of a first N-type transistor MN0 are connected, and a node G, to which a drain of a second P-type transistor MP1 and a drain of a second N-type transistor MN1 are connected. The internal resistor R0 may be configured to operate as one or more of a pull-up resistor or a pull-down resistor.

In some embodiments, the internal resistor R0 may cause transport conductance of the second P-type transistor MP1 to be at least as low as the transport conductance of the first N-type transistor MN0. In some embodiments, the internal resistor R0 may cause transport conductance of the second N-type transistor MN1 to be than at least as low as the transport conductance of the first P-type transistor MP0. However, the present inventive concepts are not limited thereto.

In addition, a first input terminal of an OR gate 360 included in the feedback circuit 132 may be connected to the node F, and a second input terminal thereof may receive an inverted signal of the fault signal FLT1. A first input terminal of an AND gate 370 may be connected to the node F, and a second input terminal thereof may receive the fault signal FLT1 independently of inversion of the fault signal FLT1.

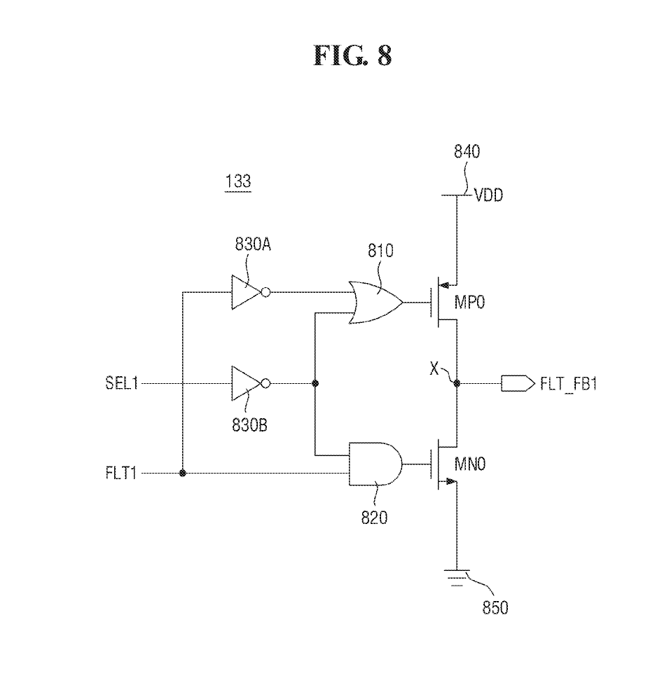

FIG. 8 is a circuit diagram of a feedback circuit 133 of a display driving circuit, according to some embodiments of the present inventive concepts.

Referring to FIG. 8, the feedback circuit 133 may include a first P-type transistor MP0, a first N-type transistor MN0, an OR gate 810, an AND gate 820, and inverters 830A-B. The feedback circuit 133 may operate in a similar manner to the feedback circuit 130 described above with reference to FIGS. 3 through 5.

The feedback circuit 133 may receive the mode selection signal SEL1 of the polarity selector circuit 120 and the fault signal FLT1 of the fault detector circuit 110. Since the first driving circuit 100 and the second driving circuit 200 are configured and operated in substantially the same way, the feedback circuit 133 included in the first driving circuit 100 will hereinafter be described.

The feedback circuit 133 may include the OR gate 810 which is configured to receive an inverted signal of the mode selection signal SEL1 and an inverted signal of the fault signal FLT1, the AND gate 820 which is configured to receive the inverted signal of the mode selection signal SEL1 and the fault signal FLT1, the first P-type transistor MP0 which is selectively activated based on an output signal of the OR gate 810, and the first N-type transistor MN0 which is selectively activated based on an output signal of the AND gate 820.

As shown in FIG. 8, a source terminal of the first P-type transistor MP0 is connected to a VDD terminal 840, and a drain terminal thereof is connected to an output terminal X. A source terminal of the first N-type transistor MN0 is connected to a GND terminal 850, and a drain terminal thereof is connected to the output terminal X. The first P-type transistor MP0 and the first N-type transistor MN0 may share the output terminal X. In some embodiments, the output terminal X may be connected to the first P-type transistor MP0 and the first N-type transistor MN0 in at least one of an open-drain or open-collector manner.

In some embodiments, the feedback circuit 133 is configured to select any one of the first N-type transistor MN0 and the first P-type transistor MP0 based on the input mode selection signal SEL1 and activate the selected transistor based on the fault signal FLT1. In some embodiments, one or more of a pull-up resistor or a pull-down resistor of the feedback circuit 133 may be located outside the feedback circuit 133.

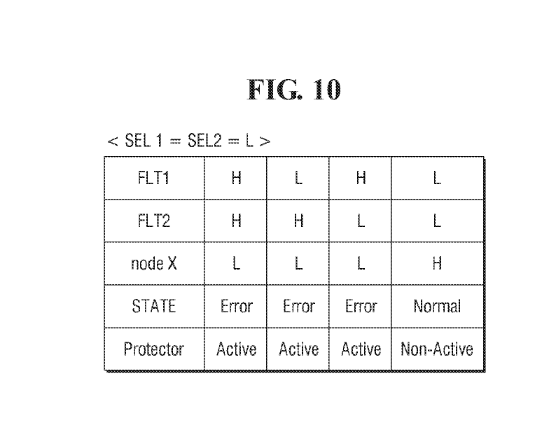

FIG. 9 is a circuit diagram illustrating the operation of the display driving circuit, according to some embodiments of the present inventive concepts. FIG. 10 is a truth table illustrating the operation of the display driving circuit, according to some embodiments of the present inventive concepts.

Referring to FIGS. 9 and 10, a first feedback circuit 133 and a second feedback circuit 233 are configured and operated in the same way as the feedback circuit 133 illustrated and discussed above with reference to FIG. 9. The feedback circuit 233 may include a first P-type transistor MP0, a first N-type transistor MN0, an OR gate 910, an AND gate 920, and inverters 930A-B. A source terminal of the first P-type transistor MP0 of the feedback circuit 233 is connected to a VDD terminal 940, and a drain terminal thereof is connected to an output terminal X. A source terminal of the first N-type transistor MN0 of feedback circuit 233 is connected to a GND terminal 950, and a drain terminal thereof is connected to the output terminal X.

In some embodiments, an output terminal X of each of the first feedback circuit 133 and the second feedback circuit 233 are connected in one or more of an open-drain or open-collector configuration, such that the output terminal X of each of the first feedback circuit 133 and the second feedback circuit 233 are connected to an individual common connection terminal P2 to which a controller 300 is coupled, as illustrated and discussed above with reference to FIG. 2.

The same mode selection signal SEL1 may be transmitted to the first feedback circuit 133 and the second feedback circuit 233, which may result in the first feedback circuit 133 and the second feedback circuit 233 operating in a common mode.

In some embodiments, including embodiments where the first feedback circuit 133 and the second feedback circuit 233 operate in a common mode which is a first mode, in response to the mode selection signal SEL1 being a low-level signal, an external pull-up resistor R1 may be connected to the output terminal X of each of the first feedback circuit unit 133 and the second feedback circuit 233. The external pull-up resistor R1 may be disposed between the output terminal X and a VDD terminal 960.

Referring to FIG. 10, the truth table shows the operation of the display driving circuit in the first mode. Specifically, the truth table shows the relationship between a voltage level of a common connection terminal (i.e., the output terminal X) and the first fault signal FLT1 transmitted to the first feedback circuit 133 and the second fault signal FLT2 transmitted to the second feedback circuit 233. In response to a fault occurring in the first display panel 1110 (see FIG. 1), the first fault signal FLT is generated as a high-level signal. In response to a fault occurring in the second display panel 1120 (see FIG. 1), the second fault signal FLT2 is generated as a high-level signal.

In some embodiments where the display driving circuit operates in the first mode, the mode selection signal SEL1 at a low level is transmitted to the first feedback circuit 133 and the second feedback circuit 233, and a voltage of the common output terminal X of each of the first feedback circuit 133 and the second feedback circuit 233 becomes a low voltage level in response to any one of the first fault signal FLT1 and the second fault signal FLT2 being a high level signal, and the voltage of the output terminal X of each of the first feedback circuit 133 and the second feedback circuit 233 becomes a high voltage level when both the first fault signal FLT1 and the second fault signal FLT2 are low-level signals, such that the first feedback circuit 133 and the second feedback circuit 233 may operate as a wired AND.

As shown at FIG. 9-10, in response to the output voltage of the output terminal X being a high voltage level, the first display panel 1110 and the second display panel 1120 are in a normal state. In response to the voltage of the output terminal X being a low voltage level, one or more of the first display panel 1110 or the second display panel 1120 is in a fault state, and the display system is not operating normally (i.e., the display system is operating in a fault state). In response to the display system operating in the fault state, the controller 300 may solve the fault of the system by generating the system recovery signal SYS_PRT.

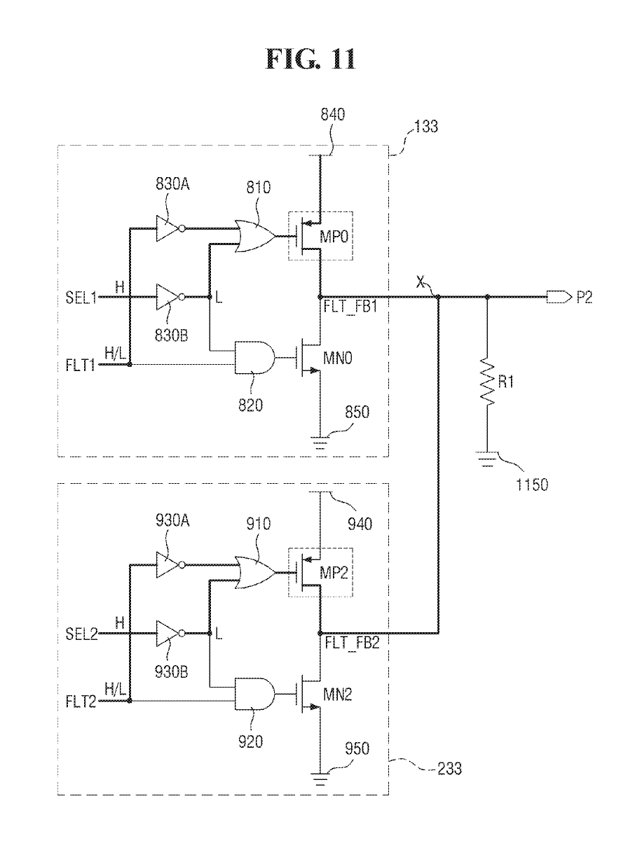

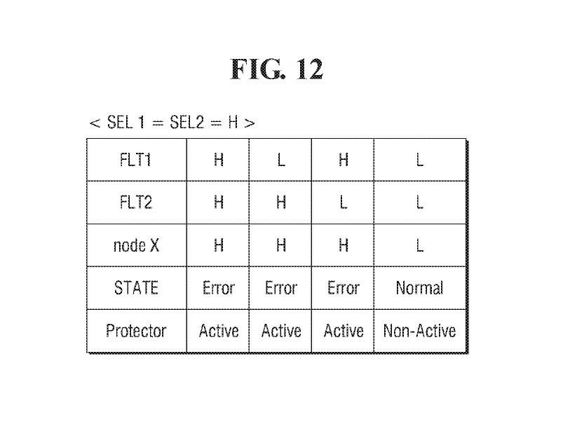

FIG. 11 is a circuit diagram illustrating the operation of the display driving circuit, according to some embodiments of the present inventive concepts. FIG. 12 is a truth table illustrating the operation of the display driving circuit, according to some embodiments of the present inventive concepts.

Referring to FIGS. 11 and 12, when the first feedback circuit 133 and the second feedback circuit 233 operate in a common mode which is a second mode, in response to the mode selection signal SEL1 being a high-level signal, an external pull-down resistor R1 may be connected to the first feedback circuit 133 and the second feedback circuit 233. The external pull-down resistor R1 may be disposed between the output terminal X and a GND terminal.

Referring to FIG. 12, the truth table shows the operation of the display driving circuit in the second mode. Specifically, the truth table shows the relationship between the voltage level of the output terminal X and the first fault signal FLT1 transmitted to the first feedback circuit 133 and the second fault signal FLT2 transmitted to the second feedback circuit 233.

In some embodiments where the display driving circuit operates in the second mode, the mode selection signal SEL1 at a high level is transmitted to the first feedback circuit 133 and the second feedback circuit 233, and the voltage of the output terminal X of each of the first feedback circuit 133 and the second feedback circuit 233 becomes a high voltage level signal in response to any one of the first fault signal FLT1 and the second fault signal FLT2 being a high-level signal, and the voltage of the output terminal X of each of the first feedback circuit 133 and the second feedback circuit 233 becomes a low voltage level when both the first fault signal FLT1 and the second fault signal FLT2 are low-level signals, such that the first feedback circuit 133 and the second feedback circuit 233 may operate as a wired OR.

As shown at FIG. 11-12, in response to the output voltage of the output terminal X being a low voltage level, the first display panel 1110 and the second display panel 1120 are in a normal state. In response to the voltage of the output terminal X being a high voltage level, one or more of the first display panel 1110 or the second display panel 1120 is in a fault state, and the display system is not operating normally (i.e., the display system is operating in the fault state). In response to the display system operating in the fault state, the controller 300 may solve the fault of the system by generating the system recovery signal SYS_PRT.

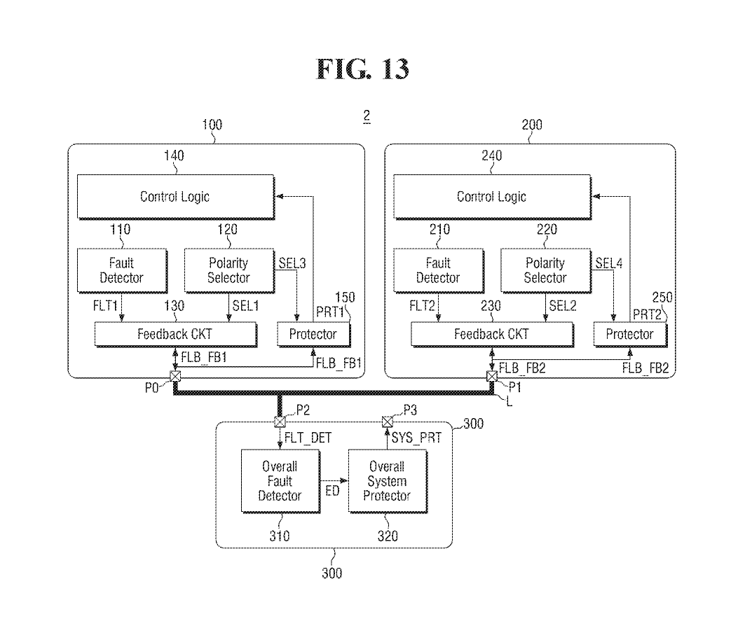

FIG. 13 is a block diagram of a semiconductor device 2 including display driving circuits, according to some embodiments of the present inventive concepts. For simplicity, a description of elements substantially identical to those of the previous embodiment will be omitted, and the current embodiment will hereinafter be described, focusing mainly on differences with the pervious embodiment.

Referring to FIG. 13, the semiconductor device 2 according to some embodiments includes a first driving circuit 100, a second driving circuit 200, and a controller 300. The first driving circuit 100, the second driving circuit 200 and the controller 300 of the semiconductor device 2 according to the some embodiments may operate in a substantially similar way to those of the semiconductor device 1 illustrated and discussed above with reference to at least FIG. 2. The first driving circuit 100 may include a first protector circuit 150 and a first control logic circuit 140. Likewise, the second driving circuit 200 may include a second protector circuit 250 and a second control logic circuit 240.

The first protector circuit 150 may receive a mode selection signal SEL3 and an output signal FLT_FB1 of a first feedback circuit 130 and output a protective signal PRT1 for a circuit device controlled by the first control logic circuit 140. Specifically, the first protector circuit 150 may generate the protective signal PRT1 for stopping the operation of the circuit device in response to the output signal FLT_FB1 of the first feedback circuit 130 being a low-level signal, where the first feedback circuit 130 is operating in a first mode. In addition, the first protector circuit 150 may generate the protective signal PRT1 in response to the output signal FLT_FB1 of the first feedback circuit 130 being a high-level signal, where the first feedback circuit 130 is operating in a second mode.

The first control logic circuit 140 may be configured to control the operation of the circuit device based on the protective signal PRT1. The first control logic circuit 140 may stop the operation of the circuit device in response to activation of the protective signal PRT1. The circuit device may include the first display panel 1110 of FIG. 1.

The second protector circuit 250 and the second control logic circuit 240 included in the second driving circuit 200 may operate in substantially the same way as the first protector circuit 150 and the first control logic circuit 140.

However, since the first protector circuit 150 and the second protector circuit 250 receive signals via a common connection terminal P2, the same signal may be transmitted to the first protector circuit 150 and the second protector circuit 250. This may be realized based on the first feedback circuit 130 and the second feedback circuit 230 being connected to the common connection terminal P2 in one or more of an open-drain or open-collector configuration.

Therefore, where a feedback signal about a fault is transmitted to the common connection terminal P2, the first protector circuit 150 and the second protector circuit 250 may receive the same feedback signal. Accordingly, the first protector circuit 150 and the second protector circuit 250 may operate simultaneously in the same manner, which may result in the first protector circuit 150 and the second protector circuit 250 generating protective signals PRT1 and PRT2 and simultaneously transmitting the generated protective signals PRT1 and PRT2 to the first control logic circuit 140 and the second control logic circuit 240.

Accordingly, when a fault occurs in any one of the display panels 1110 and 1120, the first protector circuit 150 and the second protector circuit 250 may, in response, immediately protect the display panels 1110 and 1120 without the intervention of the controller 300. In addition, the semiconductor device 2 of the present inventive concepts may perform this function without an additional interface or an additional port.

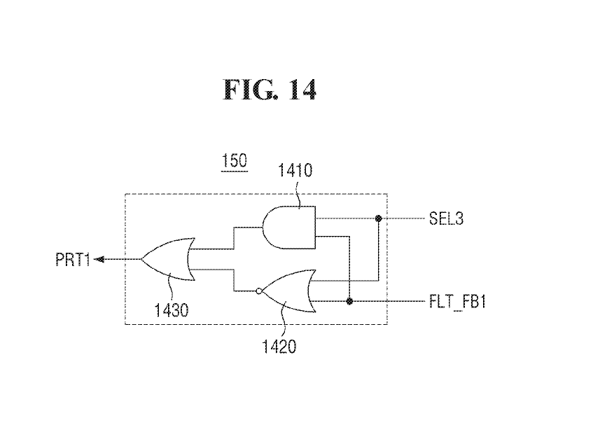

FIG. 14 is a circuit diagram of the first protector circuit 150 included in the display driving circuit, according to some embodiments of the present inventive concepts.

Referring to FIG. 14, the first protector circuit 150 may include an AND gate 1410, a NOR 1420 gate, and an OR 1430 gate.

In some embodiments, the AND gate 1410 may receive the mode selection signal SEL3 and the output signal FLT_FB1 of the first feedback circuit 130. Likewise, the NOR gate 1420 may receive the mode selection signal SEL3 and the output signal FLT_FB1 of the first feedback circuit 130. The OR gate 1430 may receive an output signal of the AND gate and an output signal of the NOR gate. Accordingly, the OR gate may output the protective signal PRT1.

For example, in response to receiving a low-level signal as the mode selection signal SEL3, the first protector circuit 150 may generate a low-level signal as the protective signal PRT1 in response to receiving a high-level signal as the output signal FLT_FB1 of the first feedback circuit 130. In another example, the first protector circuit 150 may generate a high-level signal as the protective signal PRT1 in response to receiving a low-level signal as the output signal FLT_FB1 of the first feedback circuit 130.

Conversely, in response to receiving a high-level signal as the mode selection signal SEL3, the first protector circuit 150 may generate a low-level signal as the protective signal PRT1 in response to receiving a low-level signal as the output signal FLT_FB1 of the first feedback circuit 130. In another example, the first protector circuit 150 may generate a high-level signal as the protective signal PRT1 in response to receiving a high-level signal as the output signal FLT_FB1 of the first feedback circuit 130.

In some embodiments, and in response to the first protector circuit 150 generating a high-level signal as the protective signal PRT1, the first control logic circuit 140 performs a protective function. The second protector circuit 250 may be structured and operated in the same way as the first protector circuit 150 described above.

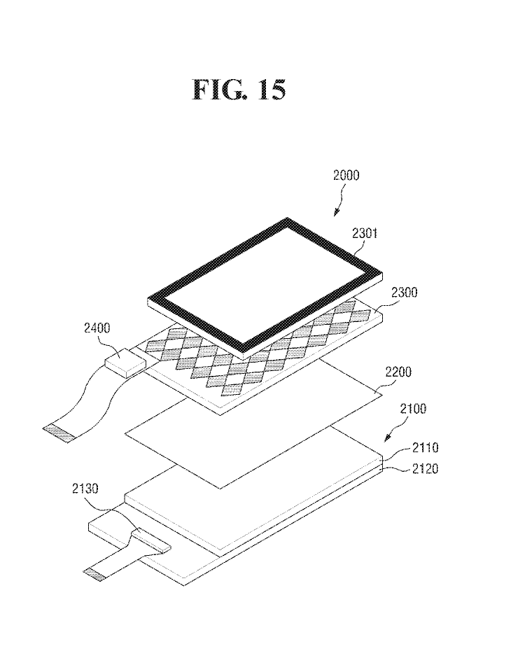

FIG. 15 illustrates a display module 2000, according to some embodiments of the present inventive concepts.

Referring to FIG. 15, the display module 2000 may include a display device 2100, a polarizing plate 2200, and a window glass 2301. The display device 2100 includes a display panel 2110, a printed circuit board (PCB) 2120, and a display driving chip 2130.

The window glass 2301 is typically made of a material such as acrylic or tempered glass in order to protect the display module 2000 from external impact or scratches due to repeated touches. The polarizing plate 2200 may be provided to improve optical characteristics of the display panel 2110. The display panel 2110 may be patterned as a transparent electrode on the PCB 2120. The display panel 2110 includes a plurality of pixel cells for displaying a frame. In some embodiments, the display panel 2110 may include an organic light-emitting diode panel. Each of the pixel cells may include an organic light-emitting diode that emits light corresponding to the flow of an electric current. However, the present inventive concepts are not limited thereto, and the display panel 2110 may also include various types of display elements. For example, the display panel 2110 may include one or more of an LCD panel, an ECD panel, a DMD panel, an AMD panel, a GLV panel, a PDP, an ELD panel, a light-emitting diode (LED) display panel, and a vacuum fluorescent display (VFD) panel.

The display driving chip 2130 may include the above-described display driving circuits 100 and 200. In some embodiments, the display driving chip 2130 is provided as one chip. However, the present inventive concepts are not limited thereto, and a plurality of driving chips may be provided. In addition, the display driving chip 2130 may be mounted on the PCB 2120 in the form of chip-on-glass (COG). However, this is merely an embodiment, and the display driving chip 2130 may be mounted in various forms, including one or more of chip-on-film (COF) and chip-on-board (COB).

The display module 2000 may further include a touch panel 2300 and a touch controller 2400. In some embodiments, the touch panel 2300 is patterned as a transparent electrode, which may include indium tin oxide (ITO), on a glass substrate or a polyethylene terephthalate (PET) film. The touch controller 2400 senses a touch on the touch panel 2300, calculates coordinates of the touch, and sends the calculated coordinates to a host (not illustrated). The touch controller 2400 may be integrated onto one semiconductor chip together with the display driving chip 2130.

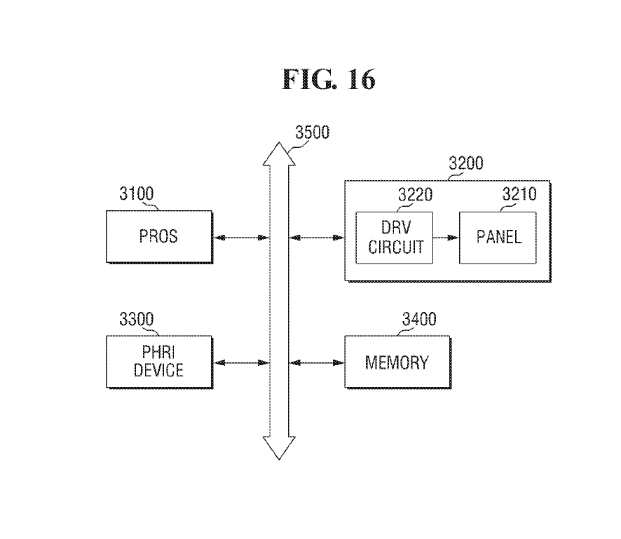

FIG. 16 illustrates a display system 3000, according to some embodiments of the present inventive concepts.

Referring to FIG. 16, the display system 3000 may include a processor 3100, a display device 3200, a peripheral device 3300, and a memory 3400 which are electrically connected to a system bus 3500.

The processor 3100 may control data input and output of the peripheral device 3300, the memory 3400 and the display device 3200 and process images of image data transmitted among these devices.

The display device 3200 includes a panel 3210 and a driving circuit 3220. The display device 3200 stores image data, which is received through the system bus 3500, in a frame memory included in the driving circuit 3220 and displays the stored image data on the panel 3210. The display device 3200 may be the display device 1 of FIG. 1. Since the display device 3200 operates asynchronously with the processor 3100, the system load on the processor 3100 may be reduced.

The peripheral device 3300 may be a device (such as a camera, a scanner, a web camera, etc.) that converts a moving or still image into an electrical signal. Image data obtained by the peripheral device 3300 may be stored in the memory 3400 or displayed on the panel 3210 of the display device 3200 in real time.

The memory 3400 may include a volatile memory element such as a dynamic random access memory (DRAM) and/or a nonvolatile memory element such as a flash memory. The memory 3400 may consist of a DRAM, a phase-change random access memory (PRAM), a magnetic random access memory (MRAM), a resistive random access memory (ReRAM), a ferroelectric random access memory (FRAM), a NOR flash memory, a NAND flash memory, and a fusion flash memory (e.g., a combination of an SRAM buffer, a NAND flash memory and a NOR interface logic). The memory 3400 may store image data obtained by the peripheral device 3300 or store an image signal processed by the processor 3100.

The display system 3000 according to the embodiments of the present inventive concepts may be included in a mobile electronic product such as a smartphone. However, the present inventive concepts are not limited thereto, and the display system 300 may also be included in various types of electronic products that display images.

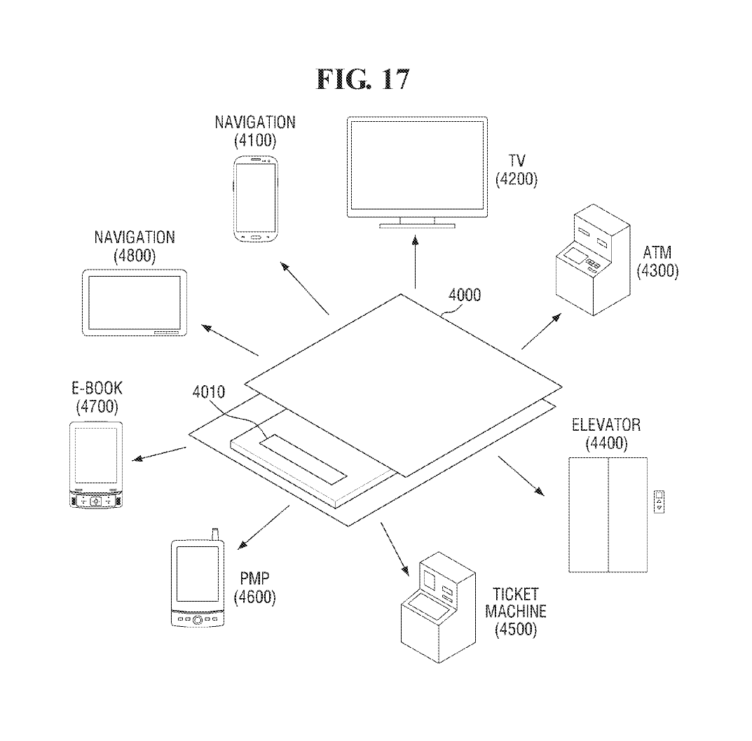

FIG. 17 illustrates various examples of an electronic product loaded with a display device 4000, according to some embodiments of the present inventive concepts.

The display device 4000 according to some embodiments of the present inventive concepts may be employed in various electronic products. Specifically, the display device 4000 may be used not only in a mobile phone 4100, but also in a wide variety of electronic products including a television 4200, an automated teller machine (ATM) 4300 which automatically accepts deposits and dispenses cash on behalf of a bank, an elevator 4400, a ticket machine 4500 which is used in, e.g., subway stations, a portable media player (PMP) 4600, an e-book 4700, and a navigation device 4800.

The display device 4000 according to some embodiments of the present inventive concepts may operate asynchronously with a system processor. Therefore, the display device 4000 reduces the driving load of the processor, enabling the processor to operate at high speed with low power consumption. Consequently, the display device 4000 may improve functions of electronic products.

While the present inventive concepts have been particularly shown and described with reference to exemplary embodiments thereof, it will be understood by those of ordinary skill in the art that various changes in form and details may be made therein without departing from the spirit and scope of the present inventive concepts as defined by the following claims. It is therefore desired that the present embodiments be considered in all respects as illustrative and not restrictive, reference being made to the appended claims rather than the foregoing description to indicate the scope of the inventive concept.

What is claimed is:

1. A display driving circuit comprising:
a fault detector circuit configured to detect a fault in a circuit device and generate a fault signal in response to the detection of the fault;
a polarity selector circuit configured to store polarity selection information and generate a mode selection signal based on the polarity selection information; and
a feedback circuit including,
an OR gate configured to receive both an inverted signal of the mode selection signal and an inverted signal of the fault signal;
an AND gate configured to receive both the inverted signal of the mode selection signal and the fault signal;
a first P-type transistor configured to selectively activate based on an output signal of the OR gate; and
a first N-type transistor configured to selectively activate based on an output signal of the AND gate.

2. The display driving circuit of claim 1, wherein the feedback circuit is configured to:
deactivate the first P-type transistor and selectively activate the first N-type transistor based on the received fault signal, in response to a determination that the mode selection signal is a first signal; and
deactivate the first N-type transistor and selectively activate the first P-type transistor based on the fault signal, in response to a determination that the mode selection signal is a second signal, the second signal being an inverted signal of the first signal.

3. The display driving circuit of claim 2, wherein the feedback circuit further comprises:
a second P-type transistor configured to operate as a pull-up resistor in response to activation of the first N-type transistor; and
a second N-type transistor configured to operate as a pull-down resistor in response to activation of the first P-type transistor.

4. The display driving circuit of claim 3, wherein
transport conductance of the second P-type transistor is lower than transport conductance of the first N-type transistor, and
transport conductance of the second N-type transistor is lower than transport conductance of the first P-type transistor.

5. The display driving circuit of claim 3, wherein the feedback circuit further comprises an internal resistor connected between:
a terminal of the first N-type transistor and the first P-type transistor, and
a terminal of the second N-type transistor and the second P-type transistor.

6. The display driving circuit of claim 1, wherein the first P-type transistor and the first N-type transistor share an output terminal, wherein the output terminal is connected in at least one of an open-drain or open-collector configuration.

7. The display driving circuit of claim 1, further comprising: an external pull-up resistor between an output terminal of the feedback circuit and a VDD terminal.

8. The display driving circuit of claim 1, further comprising: an external pull-down resistor between an output terminal of the feedback circuit and a GND terminal.

9. The display driving circuit of claim 1, further comprising:
a protector circuit configured to, in response to receiving the mode selection signal and an output signal of the feedback circuit, output a protective signal; and
a control logic circuit configured to control operation of the circuit device based on the protective signal.

10. A display driving circuit comprising:
a fault detector circuit configured to detect a fault in a circuit device and output a fault signal in response to the detection of the fault;
a polarity selector circuit configured to store polarity selection information and output a mode selection signal based on the polarity selection information; and
a feedback circuit configured to operate in a first mode when the mode selection signal is a first signal and operate in a second mode when the mode selection signal is a second signal, the second signal being an inverted signal of the first signal,
wherein the feedback circuit is configured to, when operating in the first mode, output a high-level signal when the fault signal is at a low level and output a low-level signal when the fault signal is at a high level, and
wherein the feedback circuit is configured to, when operating in the second mode, output a high-level signal when the fault signal is at a high level and output a low-level signal when the fault signal is at a low level.

11. The display driving circuit of claim 10, further comprising: a protector circuit configured to stop an operation of the circuit device when the output signal is a low-level signal when the feedback circuit is operating in the first mode or when the output signal is at a high level when the feedback circuit is operating in the second mode.

12. The display driving circuit of claim 10, wherein the circuit device includes a display panel, wherein the fault detector circuit outputs a high-level signal as the fault signal when a fault occurs in the display panel.

13. The display driving circuit of claim 10, wherein the feedback circuit includes a first N-type transistor and a first P-type transistor, wherein when the feedback circuit operates in the first mode, the first P-type transistor is deactivated, and the first N-type transistor is selectively activated based on the fault signal, and, when the feedback circuit operates in the second mode, the first N-type transistor is deactivated, and the first P-type transistor is selectively activated based on the fault signal.

14. The display driving circuit of claim 13, wherein the feedback circuit further includes a second N-type transistor and a second P-type transistor, wherein the second P-type transistor is configured to operate as a pull-up resistor when the feedback circuit operates in the first mode, and the second N-type transistor is configured to operate as a pull-down resistor when the feedback circuit operates in the second mode.

15. The display driving circuit of claim 13, wherein when the feedback circuit operates in the first mode, the first N-type transistor is configured to operate in a low active mode by outputting a high-level signal when the fault signal is at a low level and outputting a low-level signal when the fault signal is at a high level, and, when the feedback circuit operates in the second mode, the first P-type transistor is configured to operate in a high active mode by outputting a high-level signal when the fault signal is at a high level and outputting a low-level signal when the fault signal is at a low level.

16. A display driving circuit comprising:
a feedback circuit configured to receive a fault signal and a mode selection signal, the fault signal including information associated with a fault in a circuit device, the mode selection signal being based on polarity selection information; and
the feedback circuit configured to generate a first-mode output signal when the mode selection signal is a first signal and generate a second-mode output signal when the mode selection signal is a second signal, the first-mode output signal having a signal strength which is inversely proportional to a signal strength of the fault signal, the second signal being an inverted signal of the first signal, the second-mode output signal having a signal strength which is directly proportional to the signal strength of the fault signal.

17. The display driving circuit of claim 16, further comprising:
a protector circuit configured to stop an operation of the circuit device, in response to at least one of:
receiving a low-level first-mode output signal when the mode selection signal is a first signal; and
receiving a high-level second-mode output signal when the feedback circuit is operating in the second mode.

18. The display driving circuit of claim 16, further comprising:
a plurality of feedback circuits, an output terminal of each of the feedback circuits being coupled to an individual common connection terminal.

19. The display driving circuit of claim 18, further comprising:
an external pull-up resistor connected to the individual common connection terminal; and
the feedback circuits are configured to generate, at the common connection terminal, a low voltage signal based on at least one of the feedback circuits receiving a low-level fault signal.

20. The display driving circuit of claim 18, comprising:
an external pull-down resistor connected to the individual common connection terminal; and
the feedback circuits are configured to generate, at the common connection terminal, a high voltage signal based on each of the feedback circuits receiving a low-level fault signal.
